(19) United States
(12) Patent Application Publication
(10) Pub. No.: US 2012/0237812 A1
(43) Pub. Date: Sep. 20, 2012

(54) Battery Pack

(76) Inventors: Dea-Yon Moon, Yongin-si (KR); Sang-Hun Park, Yongin-si (KR)

(21) Appl. No.: 13/311,449

(22) Filed: Dec. 5, 2011

(30) Foreign Application Priority Data
Mar. 16, 2011 (KR) 10-2011-0023426

(51) Int. Cl. H01M 2/10

(52) U.S. Cl. 429/99

(57) ABSTRACT

A battery pack includes a core pack including unit cells, a frame configured to accommodate the core pack, the frame comprising first connection units, and a cover configured to cover the core pack, the cover comprising second connection units configured to be coupled to the first connection units.

### CROSS-REFERENCE TO RELATED APPLICATION

This application claims priority to and the benefit of Korean Patent Application No. 10-2011-0023426, filed in the Korean Intellectual Property Office on Mar. 16, 2011, the entire content of which is incorporated herein in by reference.

### BACKGROUND

1. Field

One or more embodiments of the present invention relate to a battery pack, and more particularly, to a structure of a battery pack.

2. Description of Related Art

Due to development of wireless Internet and communication technology, a portable computer operated by using a battery without an external power supply device has been rapidly distributed. In general, because portable computers are small and easy to carry, mobility thereof is excellent and, thus, such portable computers are widely used for business or personal use. In order to use a portable computer in various places without an external power supply device, an embedded battery pack may be included in the portable computer. Also, the embedded battery pack may include a secondary battery, which may be rechargeable.

### SUMMARY

Aspects of embodiments of the present invention are directed toward a battery pack having a connection structure in a frame accommodating a core pack and a cover coupled to the frame.

Additional aspects will be set forth in part in the description which follows, and, in part, will be apparent from the description, or may be learned by practice of the presented embodiments.

An embodiment of the present invention provides a battery pack including a core pack including unit cells, a frame configured to accommodate the core pack, the frame comprising first connection units, and a cover configured to cover the core pack, the cover comprising second connection units configured to be coupled to the first connection units.

One of the first connection units or the second connection units may include a convex unit.

The other one of the first connection units or the second connection units may have a shape corresponding to the convex unit.

The other one of the first connection units or the second connection units may include a concave unit.

The other one of the first connection units or the second connection units may have a penetrated hole.

The first connection units may further include planarization units, and inclination units located proximate an outer side of the planarization units.

The battery pack may further include guiding units located at sides of the inclination units and the planarization units, the guiding units for guiding the second connection units to couple to the first connection units.

The first connection units may further include inclination units.

The first connection units and the second connection units may have a concavo-convex interface.

The first connection units and the second connection units may be respectively located on the frame and on the cover along a thickness direction of the core pack.

The frame may have a first area configured to accommodate the core pack, and a second area configured to accommodate a protective circuit module coupled to the core pack, and the first connection units may be located at outer surfaces of the second area and may have a surface that is blocked.

The core pack may include the unit cells.

At least one of the first connection units may be at one end of the frame, and at least one other of the first connection units may be at another end of the frame.

The cover may be coupled to the frame by a tensile force between the connected first and second connection units.

The cover may include a first cover at a first side of the frame and a second cover at a second side of the frame, the frame may include a first frame unit coupled to the first cover and a second frame unit coupled to the second cover, and the first frame unit and the second frame unit may each include one or more of the first connection units.

The battery pack may further include a spacer unit between the first frame unit and the second frame unit, the first cover may be configured to be in the first frame unit, and the second cover may be configured to be in the second frame unit.

The frame may be a band-shaped rectangle corresponding to a shape of the core pack.

The cover may include a metal.

The battery pack may further include an insulation tape between the cover and the core pack.

In a battery pack according to an embodiment of the present invention, the cover may be prevented from being separated from the frame due to connection between the frame and the cover, and the frame and the cover may be easily detached.

### BRIEF DESCRIPTION OF THE DRAWINGS

These and/or other aspects will become apparent and more readily appreciated from the following description of the embodiments, taken in conjunction with the accompanying drawings, of which:

FIG. 1 is an exploded perspective view of a battery pack according to an embodiment of the present invention;

FIG. 2 is a perspective view illustrating a state in which elements of the battery pack of the embodiment shown in FIG. 1 are coupled to each other;

FIG. 3A is a perspective view schematically illustrating a frame of the embodiment shown in FIG. 1;

FIG. 3B is a perspective view schematically illustrating an enlargement of portion IIIb of FIG. 3A;

FIG. 4 is a cross-sectional view of the battery pack of the embodiment shown in FIG. 2 taken along the line IV-IV of FIG. 2;

FIG. 5 is a cross-sectional view of the battery pack of the embodiment shown in FIG. 2 taken along the line V-V of FIG. 2;

FIG. 6 is a cross-sectional view of a battery pack similar to that of the embodiment shown in FIG. 4 according to another embodiment of the present invention;

FIG. 7 is a cross-sectional view of a battery pack similar to that of the embodiment shown in FIG. 4 according to another embodiment of the present invention; and

FIG. 8 is a cross-sectional view of a battery pack similar to that of the embodiment shown in FIG. 4 according to another embodiment of the present invention.

### DETAILED DESCRIPTION

Hereinafter, one or more embodiments of the present invention will be described in detail with reference to the accompanying drawings.

The present invention will be described more fully with reference to the accompanying drawings, in which embodiments of the invention are shown. As those skilled in the art would realize, the described embodiments may be modified in various different ways, all without departing from the spirit or scope of the present invention.

The drawings and description are to be regarded as illustrative in nature and not restrictive. Further, like reference numerals designate like elements throughout the specification.

Throughout this specification and the claims that follow, when it is described that an element is “coupled” to another element, the element may be “directly coupled” to the other element or “electrically coupled” to the other element through one or more third elements. In addition, unless explicitly described to the contrary, the word “comprise” and variations such as “comprises” or “comprising” will be understood to imply the inclusion of stated elements but not the exclusion of any other elements. As used herein, the singular forms “a,” “an,” and “the,” are intended to include the plural forms as well, unless the context clearly indicates otherwise.

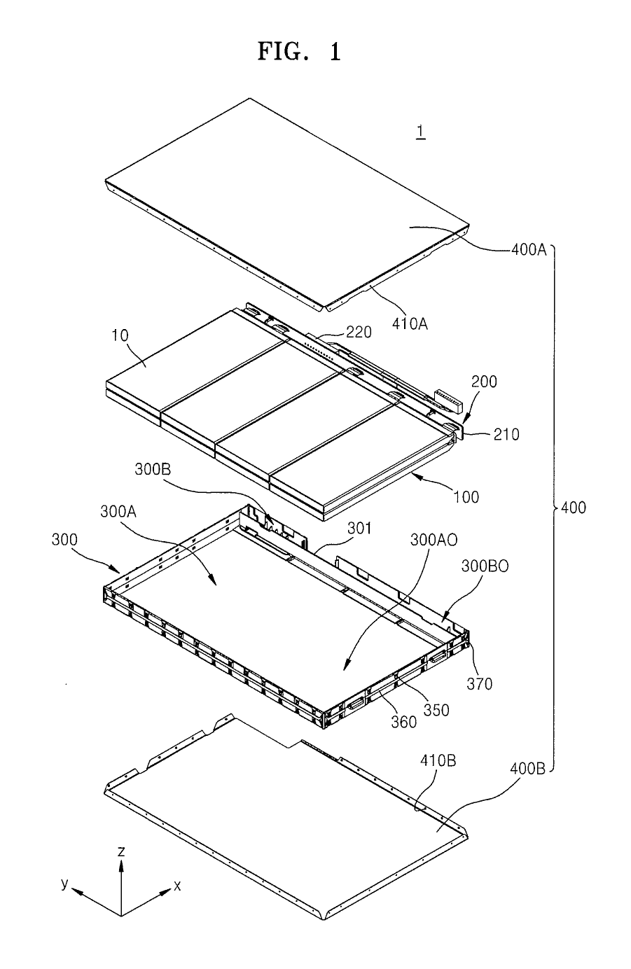

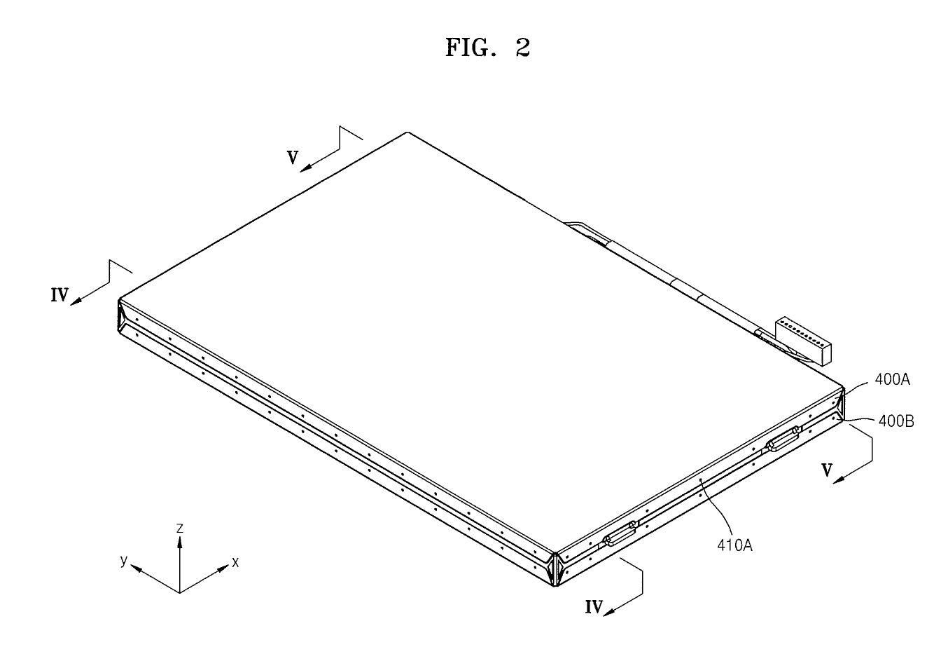

FIG. 1 is an exploded perspective view of a battery pack 1 according to an embodiment of the present invention, and FIG. 2 is a perspective view illustrating a state in which elements of the battery pack 1 are coupled to each other. Referring to FIGS. 1 and 2, the battery pack 1 includes a core pack 100, a protective circuit module 200, a frame 300, and a cover 400.

As shown in FIG. 1, the core pack 100 includes a plurality of unit cells 10. In one embodiment, the core pack 100 includes at least two unit cells 10. The unit cell 10 may be a secondary battery, for example, a lithium secondary battery. The unit cell 10 may be a polymer battery. In one embodiment, the plurality of unit cells 10 are coupled to each other in series or in parallel so as to constitute the core pack 100. Referring to the embodiment shown in FIG. 1, the core pack 100 includes eight unit cells 10. In FIG. 1, the core pack 100 includes four pairs of unit cells 10 coupled to each other in series, each pair including two unit cells 10 coupled to each other in parallel. The number of unit cells 10 constituting the core pack 100 and a connection method thereof are not limited thereto, and may vary. The core pack 100 may supply power to various electronic devices. For example, the core pack 100 may supply power to a portable computer or a machine tool.

In one embodiment, the protective circuit module 200 is electrically coupled to the core pack 100. The protective circuit module 200 may prevent overheating and/or an explosion generated due to excessive charge, excessive discharge, or excessive current. The protective circuit module 200 may include a substrate 210 located at one side of the core pack 100 and a protective device 220 installed on the substrate 210. In one embodiment, the protective device 220 selectively includes safety devices or integrated circuits each formed of passive elements, such as resistors and capacitors, or active elements, such as field effect transistors. For example, the protective device 220 may include positive temperature coefficient (PTC) devices.

In one embodiment, the frame 300 accommodates the core pack 100. Here, the frame 300 may also accommodate the protective circuit module 200 coupled to the core pack 100.

The frame 300 may be configured to include only the core pack 100 or to include both the core pack 100 and the protective circuit module 200. For example, in one embodiment, the frame 300 includes a first area 300A and a second area 300B, wherein the first area 300A may accommodate the core pack 100 and the second area 300B may accommodate the protective circuit module 200. Here, the first area 300A of the frame 300 may be partitioned by a band-shaped side wall (or side walls) that surrounds the core pack 100 so as to be substantially parallel to a thickness direction of the core pack 100 (e.g., parallel to the Z-axis in FIG. 1). Here, the second area 300B may be partitioned by a band-shaped side wall that surrounds the protective circuit module 200 so as to be substantially parallel to the thickness direction of the core pack 100. A partition wall 301 may be a common side wall that partitions the first area 300A and the second area 300B. That is, the frame 300 may be a band-shaped rectangle that is substantially parallel to the thickness direction of the core pack 100. In other words, each side of the frame may be parallel to the thickness direction of the core pack. Here, the partition wall 301 is formed as the band-shaped rectangle so as to partition the first area 300A and the second area 300B. In one embodiment, the frame 300 may be a hexahedron shape when a first opening 300AO or a second opening 300BO is covered or partially covered. Here, the cover 400 may be rectangular, when viewed from above, corresponding to the form of the frame 300. The cover 400 may be a rectangular parallelepiped by combining a first cover 400A and a second cover 400B. Also, the rectangle-form cover 400 includes an edge that extends vertically and, thus, may include second connection units 410A and 410B.

In one embodiment, the first area 300A and the second area 300B are partitioned by the partition wall 301. The first area 300A may accommodate the core pack 100 and the second area 300B may accommodate the protective circuit module 200. In one embodiment, the frame 300 includes an insulation member. The frame 300 may include a high molecular weight compound formed by plastic deformation using heat or pressure. The frame 300 including the first area 300A and the second area 300B may be configured as a single body. However, the present invention is not limited thereto, and the frame 300 may be formed from a plurality of pieces.

Here, when the core pack 100 includes a polymer battery, and the frame 300 is formed by injection molding while the core pack 100 and the protective circuit module 200 are put in a mold, a PTC device of the protective circuit module 200 may operate abnormally due to heat from the injection molding. However, in the present embodiment, the frame 300 is configured as an element separate from the core pack 100 and the protective circuit module 200, so that a defect (e.g., a defect due to heat from the injection molding) may not occur in the PTC device of the protective circuit module 200, thereby decreasing defects.

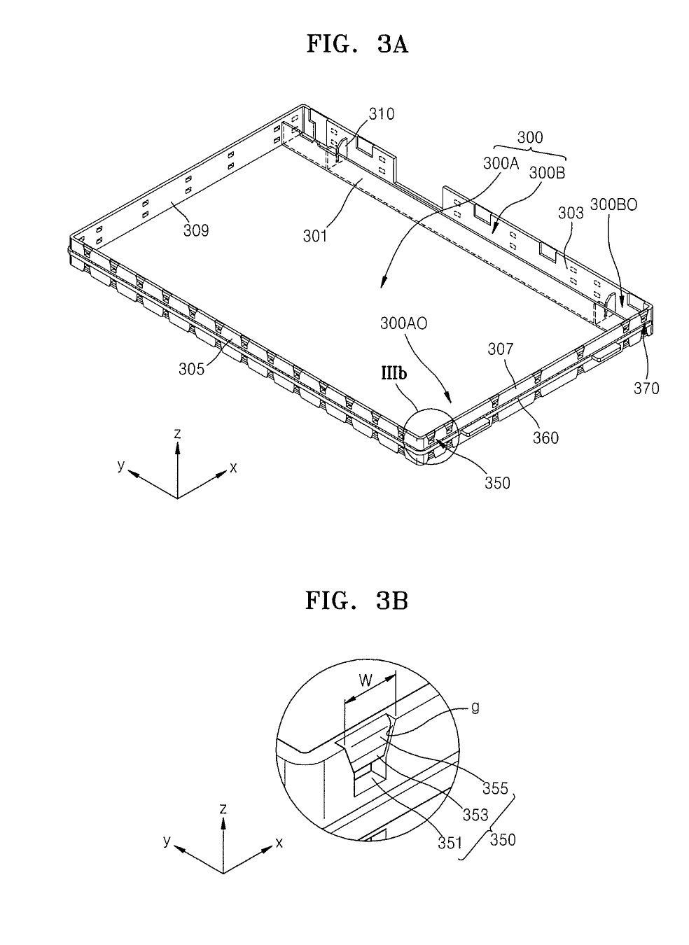

In one embodiment, the first opening 300AO is formed on at least one side surface from among a first side surface and a second side surface along a Z-axis of the first area 300A. Referring to FIGS. 3A and 3B, the first opening 300AO is formed on both surfaces of the first area 300A. The second opening 300BO may be formed on at least any one side surface from among a first side surface and a second side surface along a Z-axis of the second area 300B. The second area 300B may accommodate the protective circuit module 200 in a space formed between the partition wall 301 and one end 303 positioned to face the partition wall 301. Here, the first area 300A and the second area 300B may be divided by the partition wall 301. In the present embodiment, the second area 300B includes a support unit 310 for supporting the protective circuit module 200.

In one embodiment, the cover 400 accommodates the core pack 100 and may be combined to the frame 300. Here, in order to reduce a thickness of the battery pack 1, the cover 400 may be formed of a metal. For example, the cover 400 may be formed of stainless steel (SUS). Here, although not illustrated, an insulation tape may be interposed between the cover 400 and the core pack 100. The insulation tape may insulate the cover 400 (e.g., the metal cover) from the core pack 100. The insulation tape may also insulate the cover 400 from the protective circuit module 200.

In FIG. 1, the cover 400 is separated into the first cover 400A and the second cover 400B; however, the structure of the cover 400 is not limited thereto. For example, the cover 400 may be formed as a single body. In one embodiment, the cover 400 is a board having a thin film form. Since the cover 400 has a thin film form, the entire thickness of the battery pack 1 may be reduced. However, since the cover 400 is formed of a metal, a connection structure that facilitates combining of the cover 400 and the frame 300 may be required.

Here, when the cover 400 and the frame 300 are combined to each other using a hook, it may be hard to disassemble the cover 400 and the frame 300, or the number of hooks may be insufficient, thereby potentially causing the cover 400 to be partially separated from the frame 300. The connection structure between the frame 300 and the cover 400 is described with reference to FIGS. 1 and 2. In one embodiment, the frame 300 includes first connection units 350, and the cover 400 includes second connection units 410A and 410B, which may be coupled to the first connection units 350. The first connection units 350 and the second connection units 410A and 410B, which may be coupled to each other, may be formed in various ways.

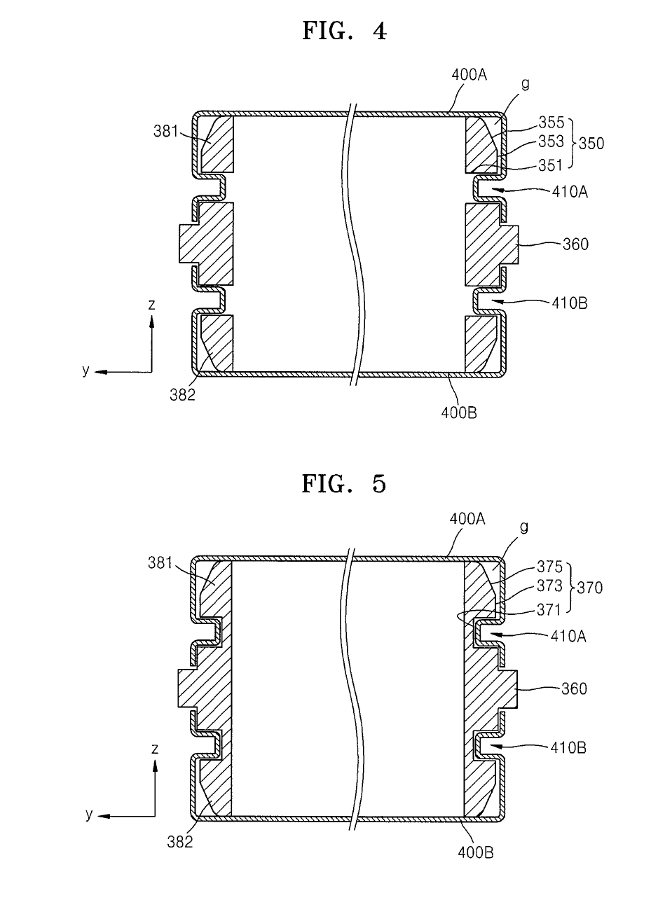

The first connection units 350 and the second connection units 410A and 410B are described with reference to FIGS. 3A, 3B, and 4. FIGS. 3A and 3B are perspective views schematically illustrating the frame 300 of the embodiment shown in FIG. 1, and FIG. 4 is a cross-sectional view of the battery pack 1 of the embodiment shown in FIG. 2 taken along the line IV-IV of FIG. 2.

Referring to FIGS. 3A, 3B, and 4, in one embodiment, the first connection units 350 each include a connection hole 351, a planarization unit 353, and an inclination unit 355. The second connection units 410A and 410B may be convex units. That is, the convex units of the second connection units 410A and 410B may be coupled to each connection hole 351 so that the first cover 400A and/or the second cover 400B may be coupled to the frame 300. In this regard, since the plurality of first connection units 350 and the second connection units 410A and 410B may be coupled to the frame 300, the first cover 400A and the second cover 400B may be prevented from being separated from the frame 300.

The first area 300A may include the partition wall 301, a first side wall 305, a second side wall 307, and a third side wall 309. The first side wall 305 may extend in a direction substantially parallel to the partition wall 301. The second side wall 307 and the third side wall 309 may each extend in a direction(s) substantially perpendicular to the first side wall 305. Accordingly, the first area 300A may have a rectangular shape surrounded by the partition wall 301, the first side wall 305, the second side wall 307, and the third side wall 309. The plurality of first connection units 350 may be formed on outer surfaces of the first area 300A, that is, outer surfaces of the first side wall 305, the second side wall 307, and the third side wall 309. In one embodiment, the plurality of first connection units 350 is formed on outer surfaces of the second area 300B.

The connection holes 351 of the first connection units 350 may be penetration holes. The planarization units 353 may be located close to the connection holes 351, and the inclination units 355 may be extended from the planarization units 353.

Guiding units g may be located at sides of the inclination units 355 and the planarization units 353, and may guide the second connection units 410A and 410B to couple to the first connection units 350. For example, in one embodiment, a width W of the planarization units 353 and/or the inclination units 355 (e.g., in the direction of the X-axis) increases along a direction (e.g., the direction of the Z-axis) away from the connection holes 351, and decreases in a direction toward the connection holes 351. Also, the guiding units g may be formed on the sides of the planarization units 353 and the inclination units 355. As the width W of the planarization units 353 and/or the inclination units 355 decreases in the direction toward the connection holes 351, the guiding units g may guide the second connection units 410A and 410B of the cover 400 to be placed in the connection holes 351.

Also, the first connection units 350 are each formed on one end and another end of the frame 300 (e.g., opposing ends of the frame 300) so that the cover 400 may be coupled to the frame 300 via tension. The cover 400 may be coupled to the frame 300 due to a tensile force occurring due to connections between the first connection units 350 and the second connection units 410A and 410B. Referring to FIG. 4, in one embodiment, the cover 400 extends along a longitudinal direction (e.g., the direction of the Y-axis), and is fixed by the first connection units 350 formed at both ends of the frame 300.

When the first connection units 350 are formed on outer surfaces of the frame 300, the first connection units 350 formed on the outer surfaces of the first area 300A may include penetrated connection holes 351. A depth of the connection holes 351 may correspond to a coupling strength between the cover 400 and the frame 300. Accordingly, since the penetrated connection holes 351 are formed on the outer surfaces of the frame 300, a sufficient coupling strength may be secured. Also, instead of the penetration holes, one end of the first connection units 350 may be blocked. For example, each first connection unit 350 may be a groove of which one end is blocked to prevent leakage of an electrolyte from the unit cells 10.

Also, in another embodiment, first connection units 370 formed on the outer surfaces of the second area 300B may include non-penetrated connection holes 371, as illustrated in FIG. 5. FIG. 5 is a cross-sectional view of the battery pack 1 of the embodiment shown in FIG. 2 taken along the line V-V of FIG. 2. The second area 300B includes the protective circuit module 200. The protective circuit module 200 includes an electronic device that is vulnerable to static electricity. When the cover 400 includes a metal, if the cover 400 is charged with external static electricity, the static electricity may be discharged to the protective circuit module 200 accommodated in the second area 300B, and thus, the protective circuit module 200 may be damaged. Accordingly, the second area 300B, which accommodates the protective circuit module 200, needs to reduce or prevent static electricity. The first connection units 370 formed on the outer surfaces of the second area 300B of the frame 300, which accommodates the protective circuit module 200 to separate the protective circuit module 200 from the cover 400, may include the non-penetrated connection holes 371. Referring to FIG. 5, the first connection units 370 may include planarization units 373. In one embodiment, the planarization units 373 are located close to the connection holes 371, and inclination units 375 extend from the planarization units 373. Here, the first connection units 370 formed on the outer surfaces of the second area 300B includes the non-penetrated connection holes 371, which may be coupled to the second connection units 410A and 410B of the cover 400, and one end thereof may be blocked, so that static electricity may be prevented from being discharged to the second area 300B.

In FIGS. 3A, 3B, 4, and 5, the first connection units 350 and 370 include the penetrated connection holes 351 in the first area 300A and the non-penetrated connection holes 371 in the second area 300B. However, the present invention is not limited thereto. For example, the first connection units 350 and 370 formed on the outer surfaces of the first area 300A and the second area 300B might include only the non-penetrated connection holes 371. Also, the first connection units 350 of the first area 300A may include the non-penetrated connection holes 371, and the first connection units 370 of the second area 300B may include the penetrated connection holes 351.

The number, form, and location of the first connection units 350 and 370 illustrated in FIGS. 3A, 3B, 4, and 5 are only examples and are not limited thereto.

Spacer units 360 are now described with reference to FIGS. 4 and 5. The frame 300 may include a first frame unit 381 coupled to the first cover 400A and a second frame unit 382 coupled to the second cover 400B. Here, the first connection units 350 may be formed on the first frame unit 381 and the second frame unit 382 so as to couple the first and second covers 400A and 400B to the frame 300. The spacer units 360 that protrude between the first cover 400A and the second cover 400b may be formed between the first frame unit 381 and the second frame unit 382. The spacer unit 360 partitions a space so that the first cover 400A does not contact the second cover 400B, and guides the first cover 400A and the second cover 400B to be aligned with each other (e.g., to be placed on predetermined locations.

Here, a plurality of the first connection units 350 and 370 and the second connection units 410A and 410B may be formed along the thickness direction (e.g., the Z-axis direction) of the core pack 100. The first connection units 350 and 370 and the second connection units 410A and 410B may be positioned to be substantially symmetrical with each other, or may be arranged alternately along opposite sides of the spacer units 360.

In one embodiment, any one of the first connection units 350 and 370 or the second connection units 410A and 410B may be formed to include convex units. The other one of the first connection units 350 and 370 or the second connection units 410A and 410B may be shaped to correspond to the convex units. Here, the other one of the first connection units 350 and 370 or the second connection units 410A and 410B may be concave units and penetrated holes.

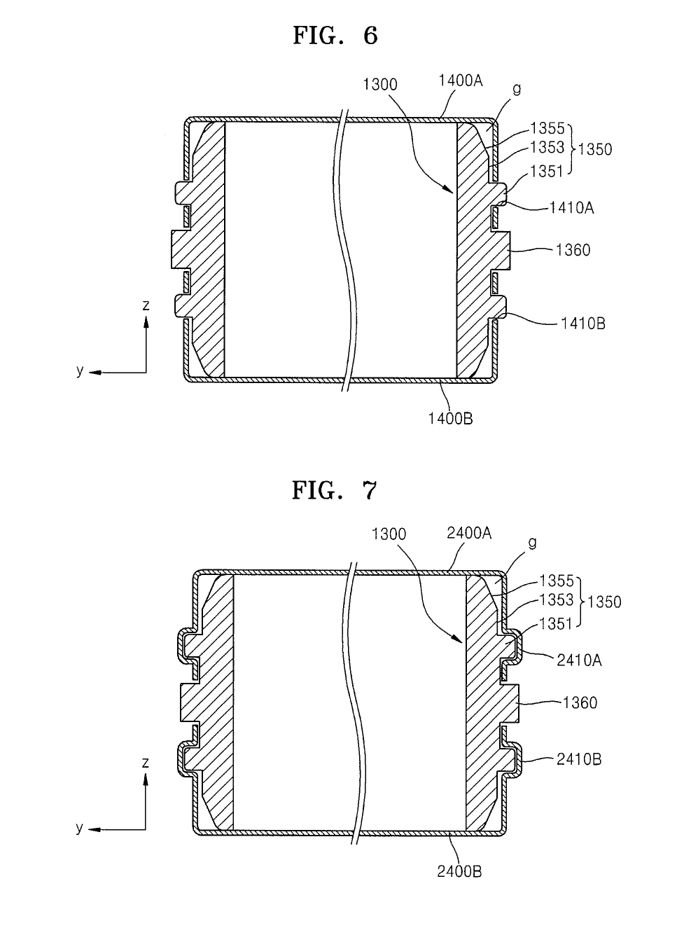

Various modifications of the first connection units 350 and the second connection units 410A and 4108 of the frame 300 and the cover 400 are now described with reference to FIGS. 6 through 8. FIGS. 6 through 8 illustrate modifications of the embodiment of the present invention shown in FIG. 4.

Referring to FIG. 6, a first connection unit 1350 formed on a frame 1300 may include a convex unit 1351, a planarization unit 1353, and an inclination unit 1355. Here, the convex unit 1351 may extend in a direction away from the frame 1300. A first cover 1400A may include a second connection unit 1410A corresponding to the convex unit 1351. Here, the second connection unit 1410A may be a penetrated connection hole. The convex unit 1351 is coupled to the second connection unit 1410A, in which a connection hole is formed, so that the first cover 1400A may be coupled to the frame 1300. A second cover 1400B may be coupled to the frame 1300 using a method similar to the method described above.

Referring to FIG. 7, the first connection unit 1350 formed on the frame 1300 may include the convex unit 1351, the planarization unit 1353, and the inclination unit 1355. In a first cover 2400A, a second connection unit 2410A may include a concave unit in correspondence to the first connection unit 1350. Accordingly, the convex unit 1351 of the first connection unit 1350 is coupled to the concave unit of the second connection unit 2410A so as to couple the first cover 2400A to the frame 1300. A second cover 2400B may be coupled to the frame 1300 using a method similar to the method described above.

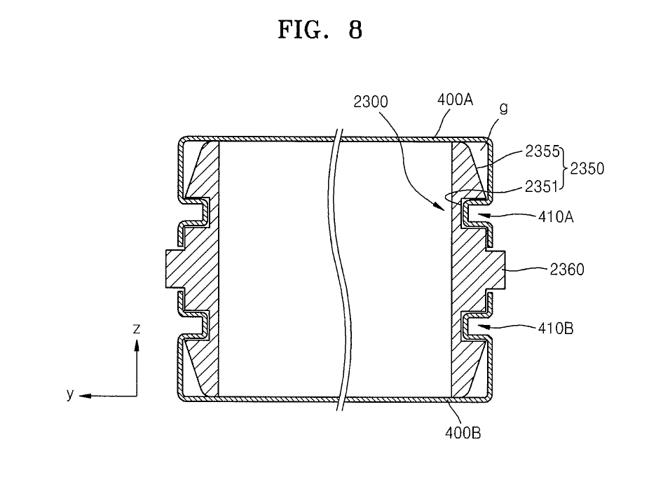

Referring to FIG. 8, a first connection unit 2350 formed on a frame 2300 may include a connection hole 2351 and an inclination unit 2355. Here, a convex unit of each second connection unit 410A of the first cover 400A is supported by the connection hole 2351 so as to couple the frame 2300 to the first cover 400A. Here, the first connection unit 2350 may be a penetrated hole or non-penetrated hole.

It should be understood that the exemplary embodiments described herein should be considered in a descriptive sense only, and not for purposes of limitation. Descriptions of features or aspects within each embodiment should typically be considered as available for other similar features or aspects in other embodiments.

Although exemplary embodiments of the present invention have been described for illustrative purposes, those skilled in the art will appreciate that various modifications and changes thereof are possible without departing from the scope and spirit of the present invention, and the scope of the invention is defined by the appended claims and their equivalents.

What is claimed is:

1. A battery pack comprising:
a core pack comprising unit cells;
a frame configured to accommodate the core pack, the frame comprising first connection units; and
a cover configured to cover the core pack, the cover comprising second connection units configured to be coupled to the first connection units.

2. The battery pack of claim 1, wherein one of the first connection units or the second connection units comprises a convex unit.

3. The battery pack of claim 2, wherein the other one of the first connection units or the second connection units has a shape corresponding to the convex unit.

4. The battery pack of claim 3, wherein the other one of the first connection units or the second connection units comprises a concave unit.

5. The battery pack of claim 3, wherein the other one of the first connection units or the second connection units has a penetrated hole.

6. The battery pack of claim 1, wherein the first connection units further comprise:
planarization units; and
inclination units located proximate an outer side of the planarization units.

7. The battery pack of claim 6, further comprising guiding units located at sides of the inclination units and the planarization units, the guiding units for guiding the second connection units to couple to the first connection units.

8. The battery pack of claim 1, wherein the first connection units further comprise inclination units.

9. The battery pack of claim 1, wherein the first connection units and the second connection units have a concavo-convex interface.

10. The battery pack of claim 1, wherein the first connection units and the second connection units are respectively located on the frame and on the cover along a thickness direction of the core pack.

11. The battery pack of claim 1, wherein the frame has a first area configured to accommodate the core pack, and a second area configured to accommodate a protective circuit module coupled to the core pack, and wherein the first connection units are located at outer surfaces of the second area and have a surface that is blocked.

12. The battery pack of claim 1, wherein the core pack comprises the unit cells.

13. The battery pack of claim 1, wherein at least one of the first connection units is at one end of the frame, and at least one other of the first connection units is at another end of the frame.

14. The battery pack of claim 13, wherein the cover is coupled to the frame by a tensile force between the connected first and second connection units.

15. The battery pack of claim 1, wherein the cover comprises:
a first cover at a first side of the frame; and
a second cover at a second side of the frame,
wherein the frame comprises a first frame unit coupled to the first cover and a second frame unit coupled to the second cover, the first frame unit and the second frame unit each comprising one or more of the first connection units.

16. The battery pack of claim 15, further comprising a spacer unit between the first frame unit and the second frame unit, wherein the first cover is configured to be in the first frame unit, and the second cover is configured to be in the second frame unit.

17. The battery pack of claim 1, wherein the frame is a band-shaped rectangle corresponding to a shape of the core pack.

18. The battery pack of claim 1, wherein the cover comprises a metal.

19. The battery pack of claim 1, further comprising an insulation tape between the cover and the core pack.
